(19) United States
(12) Patent Application Publication
(10) Pub. No.: US 2011/0027036 A1
(43) Pub. Date: Feb. 3, 2011

(54) BOSS ENGAGING APPARATUS FOR PORTABLE COMMUNICATION DEVICE

(75) Inventors: Jung-Bae PARK, Daegu (KR); Jin-Woo KIM, Gyeongsangbuk-do (KR); Sung-Wook KANG, Seoul (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/839,487

(22) Filed: Jul. 20, 2010

(30) Foreign Application Priority Data
Jul. 28, 2009 (KR) 10-2009-0068731

(51) Int. Cl. F16B 39/00

(52) U.S. Cl. 411/81

(57) ABSTRACT

A boss engaging apparatus for a portable communication device, the boss engaging apparatus including first and second boss housings formed in front and rear cases of the portable communication device, respectively, a screw engaging portion formed in the first boss housing, a screw tap provided in the second boss housing, and a screw-in portion formed in the screw engaging portion to protrude in an opposite direction to a direction of screw engagement and deformed in the direction of the screw engagement as contacting the screw during the screw engagement.

### CLAIM OF PRIORITY

This application claims the benefit under 35 U.S.C. §119(a) of a Korean Patent Application filed in the Korean Intellectual Property Office on Jul. 28, 2009 and assigned Serial No. 10-2009-0068731, the entire disclosure of which is hereby incorporated by reference.

### BACKGROUND OF THE INVENTION

1. Field of the Invention

The present invention relates to a boss engaging apparatus for a portable communication device which includes a screw-in portion for providing an elastic force by being deformed to counter an engaging stress caused by screw-engagement with a boss.

2. Description of the Related Art

Generally, portable communication devices represents devices by which radio communication can be performed while the devices are being roamed and include a hand-held phone (HHP), cordless telephone (CT-)2 cellular phone, a digital phone, a personal communications systems (PCS) phone, and a personal digital assistant (PDA), etc. The wireless terminals are typically classified into bar-type wireless terminals, flip-type wireless terminal, and folder-type wireless terminals. The bar-type terminal has a single housing shaped like a bar. The flip-type terminal has a flip or cover pivotably mounted to a bar-shaped housing by a hinge unit. The folder-type terminal has a folder coupled to a single bar-shaped housing by a hinge unit in such a manner that the folder can be rotated to fold to or unfold from the housing. All these portable communication devices are provided with an antenna unit, data input/output units, and data transmitting/receiving units. The data input unit usually includes a keypad with which data is input by means of activating buttons. Alternatively, a touch pad or a touch screen can be used.

As shown in FIG. 1, a portable communication device 1 includes a housing which includes a front case 1a and a rear case 1b. In each of the front case 1a and the rear case 1b, a plurality of bosses 3 and 4 are formed to engage the front case 1a with the rear case 1b by means of a screw 2.

The bosses 3 and 4 include boss housings 3a and 4a and screw engaging portions 3b and 4b in the boss housings 3a and 4a. In the screw engaging portions 3b and 4b is formed a screw hole 3c for engagement with the screw 2.

However, such conventional bosses come loose because a repelling force against screw engagement between inserts is weakened by successive external shocks due to external abuse conditions of the portable communication device, such as unwrapped drop and frequent fall.

Moreover, as shown in FIGS. 2A and 2B, in the conventional bosses 3 and 4, when the screw 2 is engaged into the boss housings 3a and 4a of the cases 1a and 1b, a strong engaging force may generate an engaging stress in the screw hole 3c and a head portion of the screw 2, causing indentation and deformation. If an excessive force is exerted on the screw hole 3c by increasing the engaging rotation of the screw 2, the bosses 3 and 4 would be damaged due to an increase in the engaging stress.

In addition, a gap is generated between the cases of the portable communication devices due to the loose screw. As a result, shield cans (shielding portions) provided in a printed circuit board also have a gap therebetween, thus weakening a shielding force and degrading the radiation performance of an antenna.

Furthermore, the gap between the cases of the portable communication device spoils the appearance of the portable communication device and induces friction noise.

Accordingly, there is a need for an engaging apparatus which prevents a boss from being damaged by an increased the screw engaging rotation and robust against an engaging force when a screw is engaged with the boss of the portable communication device.

### SUMMARY OF THE INVENTION

An aspect of the present invention is to address at least the above problems and/or disadvantages and to provide at least the advantages described below. Accordingly, an aspect of the present invention is to provide a boss engaging apparatus for a portable communication device, which includes a screw-in portion for providing an elastic force by being deformed in screw-engagement with a boss, thus providing a reacting force against an engaging stress caused by the screw engagement, whereby the boss can be prevented from being damaged in the screw engagement without the need of an additional part which in turn contributes a cost reduction.

Another aspect of the present invention is to provide a boss engaging apparatus for a portable communication device, which includes a screw-in portion for providing an elastic force by being deformed in screw-engagement with a boss to provide a reacting force against an engaging stress caused by the screw engagement, whereby the boss engaging force can be improved by continuously providing the reacting force, and whereby unscrewing can be prevented in spite of an external shock or a fall.

According to an aspect of the present invention, there is provided a boss engaging apparatus for a portable communication device, the boss engaging apparatus including first and second boss housings formed in front and rear cases of the portable communication device, respectively, a screw engaging portion formed in the first boss housing, a screw tap provided in the second boss housing, and a screw-in portion formed in the screw engaging portion to protrude in an opposite direction to a direction of screw engagement and deformable in the direction of the screw engagement as contacting the screw during the screw engagement.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is an exploded perspective view of a conventional boss engaging apparatus for a portable communication device;

FIG. 2A is a cross-sectional view showing a coupled state of the conventional boss engaging apparatus shown in FIG. 1;

FIG. 2B is a cross-sectional view showing a use state of the conventional boss engaging apparatus shown in FIG. 1;

FIG. 3 is a perspective view of a boss engaging apparatus for a portable communication device according to an embodiment of the present invention;

FIG. 4 is a perspective view of a first boss housing of the boss engaging apparatus for the portable communication device according to a first embodiment of the present invention;

FIG. 5A is a cross-sectional view showing a before-operation (pre-operation) state of the boss engaging apparatus for the portable communication device according to the first embodiment of the present invention;

FIG. 5B is a cross-sectional view showing an in-operation state of the boss engaging apparatus for the portable communication device according to the first embodiment of the present invention;

FIG. 6 is a perspective view of another example of the first boss housing of the boss engaging apparatus for the portable communication device according to a second embodiment of the present invention;

FIG. 7A is a cross-sectional view of another example of the first boss housing of the boss engaging apparatus for the portable communication device according to the second embodiment of the present invention, in which a pre-operation state thereof is shown;

FIG. 7B is a cross-sectional view of another example of the first boss housing of the boss engaging apparatus for the portable communication device according to the second embodiment of the present invention, in which an in-operation state thereof is shown;

FIG. 8A is a cross-sectional view of another example of the first boss housing of the boss engaging apparatus for the portable communication device according to a third embodiment of the present invention, in which a state prior to an increase in the screw engaging rotation is shown; and

FIG. 8B is a cross-sectional view of another example of the first boss housing of the boss engaging apparatus for the portable communication device according to a third embodiment of the present invention, in which a state after an increase in the screw engaging rotation is shown.

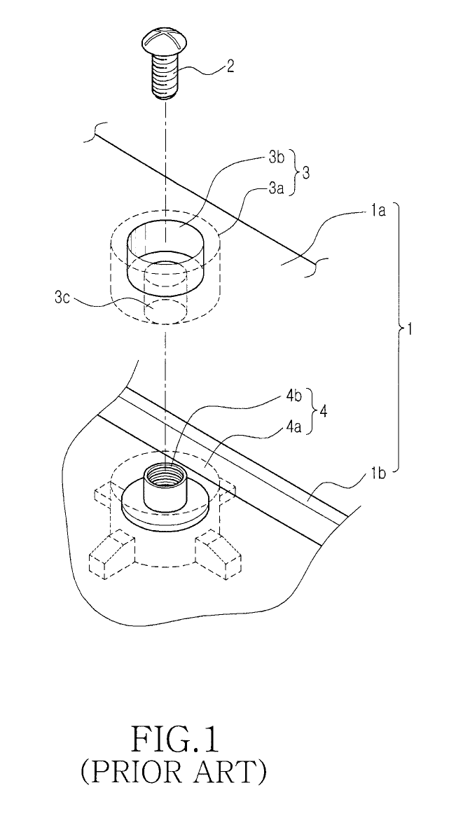

### DETAILED DESCRIPTION OF THE INVENTION

Hereinafter, an exemplary embodiment of the present invention will be described in detail with reference to the accompanying drawings. It should be understood that the embodiment described herein and structures shown in the drawings are merely illustrative and various modifications which can substitute for the embodiment and structures can be made at the time of filing the present application.

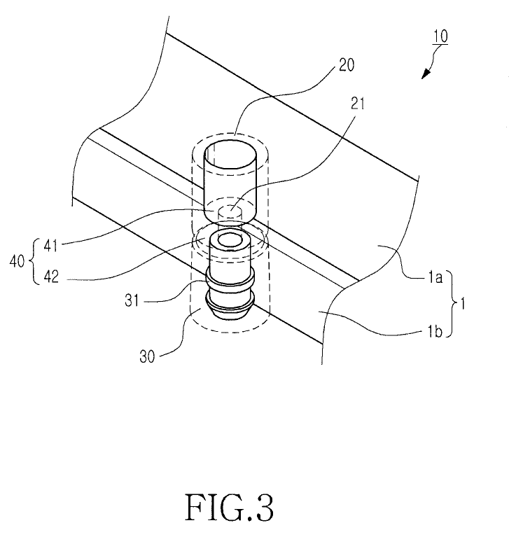

Referring to FIGS. 3 through 8B, a boss engaging apparatus 10 for a portable communication device 1 includes a front case 1a, a rear case 1b, a first boss housing 20, a second boss housing 30, a screw engaging portion 21, a screw tap 31, and a screw-in portion 40.

As shown in FIGS. 3 through 5B, the first boss housing 20 and the second boss housing 30 are formed in the front case 1a and the rear case 1b, respectively, to engage the front case 1a with the rear case 1b by means of a screw 2. The screw engaging portion 21 is formed in the first boss housing 20 for screw engagement with the screw tap 31 by means of the screw 2. The screw tap 31 is provided in the second boss housing 30 for screw-engagement with the screw engaging portion 21 by means of the screw 2. The screw-in portion 40 protrudes in the opposite direction to the direction of the screw-engagement. The screw-in portion 40 is formed in the screw engaging portion 21 such that it is deformed along the direction of the screw engagement as it contacts a head portion of the screw 2.

During the screw engagement, the screw-in portion 40 providing an elastic force is deformed by a push pressure, thus providing a reacting force against an engaging stress generated in the screw tap 31 and the screw engaging portion 21.

The screw-in portion 40 is in the shape of a dish with concave or curved form toward the center which is deformed by a push pressure during screw engagement. The screw tap 31 is provided by insert-injection process.

In the screw in portion 40 is formed an elastic space 50 for providing an elastic force during the screw engagement.

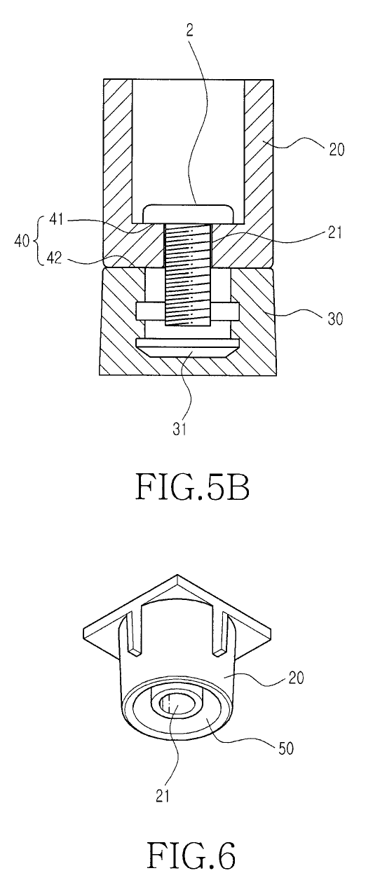

As shown in FIGS. 5A and 5B, on a top surface of the screw-in portion 40 is formed a first contact surface 41 for contacting the head portion of the screw 2, and on a bottom surface of the screw-in portion 40 is formed a second contact surface 42 for contacting a top surface of the screw tap 31.

Hereinafter, an operation of the boss engaging apparatus 10 for the portable communication device 1 according to an embodiment of the present invention will be described in more detail with reference to FIGS. 3 through 8B.

As shown in FIGS. 3 through 5B, the boss engaging apparatus 10 includes the front case 1a, the rear case 1b, the first boss housing 20, the second boss housing 30, the screw engaging portion 21, the screw tap 31, and the screw-in portion 40.

In the front case 1a and the rear case 1b are formed the first boss housing 20 and the second boss housing 30, respectively.

The screw engaging portion 21 is formed in the first boss housing 20.

The screw tap 31 is provided in the second boss housing 30 by insert-injection.

In this state, as shown in FIGS. 5A and 5B, for screw-engagement between the front case 1a and the rear case 1b, the screw 2 is inserted into the first boss housing 20 and then is engaged with the screw engaging portion 21 by rotation.

As shown in FIG. 5A, the head portion of the screw 2 contacts the first contact surface 41 provided on the top surface of the screw-in portion 40. The screw 2 is screw-engaged with the screw tap 31 provided in the second boss housing 30.

In this state, as shown in FIG. 5B, if the screw 2 is continuously rotated, the head portion of the screw 2 pushes the first contact surface 41 of the screw-in portion 40, and the screw-in portion 40 is deformed by the push pressure while providing an elastic force, such that the second contact surface 42 provided on the bottom surface of the screw-in portion 40 contacts the top surface of the screw tap 31.

Through the elastic force generated with the deformation, the screw-in portion 40 continuously provides a reacting force against an engaging stress generated in the screw tap 31 and the screw engaging portion 21 of the screw 2, thereby preventing the screw 2 from being loosen while improving the engaging force.

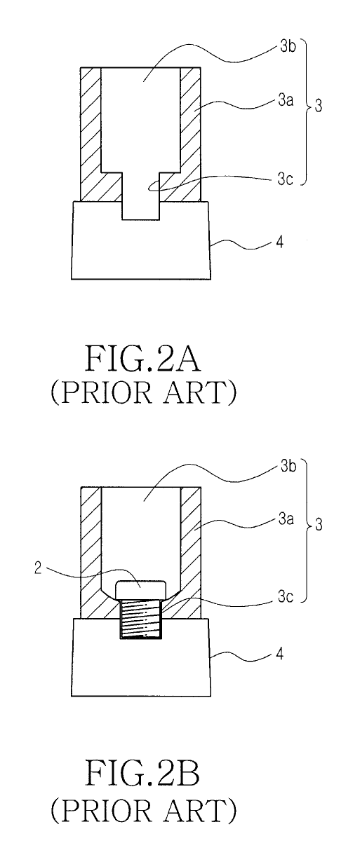

Conventionally, as shown in FIGS. 2A and 2B, the head portion of the screw 2 concentrates the engaging stress to the screw engaging portion 21 during the screw-engagement with a boss, thus indenting and damaging the boss. However, as shown in FIGS. 5A and 5B, the screw-in portion 40 is formed in the screw engaging portion 21 and deformed according to the engaging stress of the screw 2, thereby absorbing the engaging stress with the elastic force, thus providing the reacting force. As a result, it prevents the screw engaging portion 21 from being indented and damaged.

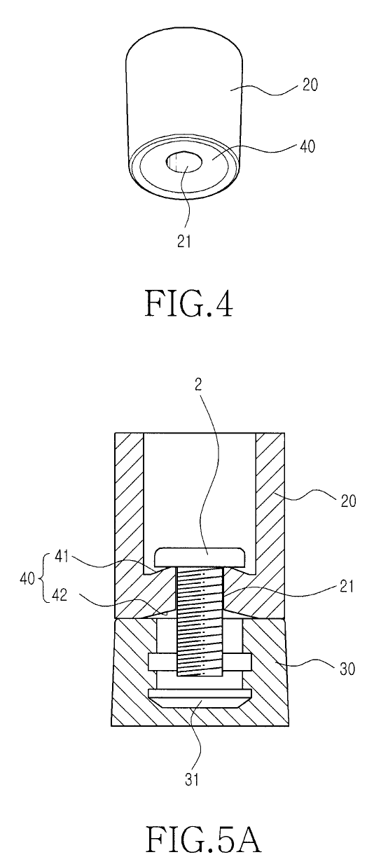

FIGS. 6 through 8B show another example of the screw-in portion 40 according to a second and third embodiment. The second embodiment shown in FIG. 6 is substantially similar to the embodiment shown in FIG. 4, except that in the screw-in portion 40 is formed an elastic space 50 for providing an elastic force during the screw engagement. In particular, the elastic force 50 according to the second embodiment includes a flat but an angled inner portion and the third embodiment includes a round portion. Both elastic force 50 in the second and third embodiments is formed to increase the elastic force during screw engagement. Hence, the discussion of similar components described in the preceding paragraphs is omitted to avoid redundancy.

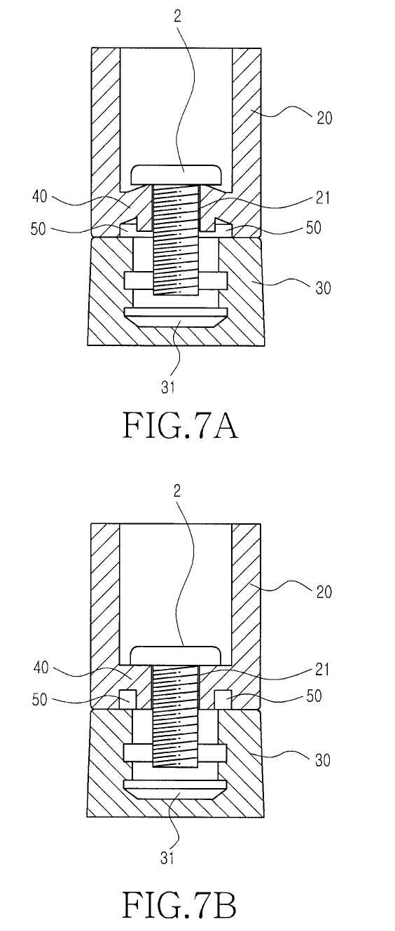

In the second embodiment, as shown in FIGS. 7A and 7B, the elastic space 50 is deformed and provides the reacting force against the engaging stress through the elastic force as the rotation of the screw 2 is increased during the screw engagement, thereby preventing the screw engaging portion 21 from being indented and adjusting the rotation of the screw 2.

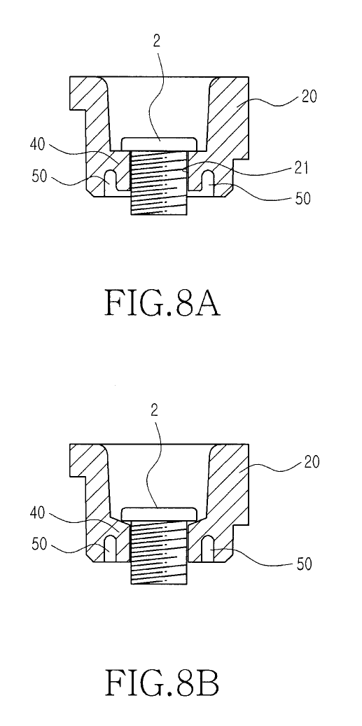

In the third embodiment, as shown in FIGS. 8A and 8B, when the rotation of the screw 2 is increased by an excessive force during the screw engagement, the deformation of the elastic space 50 is increased to provide the reacting force against the increased engaging stress through the elastic force, thereby preventing the screw engaging portion 21 from being indented and damaged and adjusting the rotation of the screw 2.

The previous description of the preferred embodiments is provided to enable any person skilled in the art to make or use the present invention. It would be obvious to those of ordinary skill in the art that the above-described boss engaging apparatus for a portable communication device according to the present invention is not limited to the foregoing embodiments and drawings, and various substitutions, modifications, and changes may be made therein without departing from the spirit and scope of the invention.

What is claimed is:

1. A boss engaging apparatus for a portable communication device, comprising:
first and second boss housings formed in front and rear cases of the portable communication device, respectively;
a screw engaging portion formed in the first boss housing;
a screw tap provided in the second boss housing; and
a screw-in portion formed in the screw engaging portion to protrude in an opposite direction to a direction of screw engagement and deformable in the direction of the screw engagement as contacting the screw during the screw engagement.

2. The boss engaging apparatus of claim 1, wherein the screw-in portion is formed in the shape of a dish.

3. The boss engaging apparatus of claim 1, wherein the screw tap is provided by insert-injection.

4. The boss engaging apparatus of claim 1, wherein the screw-in portion is provided with an elastic force formed therein to provide an elastic force during the screw engagement.

5. The boss engaging apparatus of claim 1, wherein a first contact surface contacting a head portion of the screw interfaces a top surface of the screw-in portion, and a second contact surface contacting a top surface of the screw tap interfaces a bottom surface of the screw-in portion.

6. The boss engaging apparatus of claim 1, wherein the screw-in portion is deformed by a push pressure and provides an elastic force during the screw engagement.

7. The boss engaging apparatus of claim 1, wherein the screw-in portion provides a reacting force against an engaging stress generated in the screw tap.

8. The boss engaging apparatus of claim 6, further comprising an elastic spaced formed in the screw-in portion to provide the elastic force during the screw engagement.

9. The boss engaging apparatus of claim 8, wherein one end of the elastic space is defined by a flat and an angled inner portion.

10. The boss engaging apparatus of claim 8, wherein one end of the elastic space is defined by a round portion.

11. A boss engaging apparatus for a portable communication device, comprising:
at least one or more boss housings formed in the portable communication device;
a screw engaging portion formed in the boss housings; and
a screw-in portion formed in the screw engaging portion to protrude in an opposite direction to a direction of screw engagement and deformable in the direction of the screw engagement as contacting the screw during the screw engagement.

12. The boss engaging apparatus of claim 11, wherein the screw-in portion provides an elastic force against an engaging stress during the screw engagement.

13. The boss engaging apparatus of claim 11, wherein the screw-in portion is deformable during the screw engagement.

14. The boss engaging apparatus of claim 11, further comprising an elastic spaced formed in the screw-in portion to provide the elastic force during the screw engagement.

15. The boss engaging apparatus of claim 14, wherein one end of the elastic space is defined by a flat and an angled inner portion.

16. The boss engaging apparatus of claim 14, wherein one end of the elastic space is defined by a round portion.
